(19) United States
(12) Patent Application Publication
(10) Pub. No.: US 2025/0217988 A1
(43) Pub. Date: Jul. 3, 2025

(54) IMAGE SEGMENTATION MASK REFINEMENT WITH DIFFUSION MODEL

(71) Applicants: Lemon Inc., Grand Cayman (KY); Beijing Jiaotong University, Beijing (CN)

(72) Inventors: Mengyu WANG, Beijing (CN); Jun Hao LIEW, Singapore (SG); Jiajun LIU, Beijing (CN); Yao ZHAO, Beijing (CN); Yunchao WEI, Beijing (CN)

(21) Appl. No.: 18/397,994

(22) Filed: Dec. 27, 2023

(51) Int. Cl. G06T 7/11

(52) U.S. Cl. CPC G06T 7/11; G06T 2207/20081; G06T 2207/20084

(57) ABSTRACT

A computing system includes a processor and a storage device holding instructions executable by the processor to receive an initial image segmentation mask for an image. The initial image segmentation mask is input to a diffusion model trained to change pixel values of a plurality of mask pixels of the image segmentation mask to thereby generate a refined image segmentation mask for the image. The refined image segmentation mask is output.

### BACKGROUND

Image segmentation is a computer vision task that aims to partition a digital image into multiple segments based on the image's content. This technology has a wide range of applications, including image processing, medical imaging, autonomous vehicle navigation, etc. In some cases, the image segmentation process includes generating an image segmentation mask that distinctly labels different parts of the image—e.g., to thereby distinguish objects from the background or identify specific features within the image.

### SUMMARY

According to one aspect of the present disclosure, a computing system is provided. The computing system includes a processor and a storage device holding instructions executable by the processor to receive an initial image segmentation mask for an image. The initial image segmentation mask is input to a diffusion model trained to change pixel values of a plurality of mask pixels of the image segmentation mask to thereby generate a refined image segmentation mask for the image. The refined image segmentation mask is output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system implementing a diffusion model for image segmentation mask refinement.

FIG. 2 schematically illustrates forward and reverse diffusion phases of a diffusion model.

FIG. 3 schematically illustrates iterative generation of a refined image segmentation mask from an initial image segmentation mask.

FIGS. 4A and 4B illustrate example algorithms for training and

inference with a diffusion model for image segmentation mask refinement.

FIG. 5 illustrates an example method for image segmentation mask refinement.

FIG. 6 schematically shows an example computing system.

### DETAILED DESCRIPTION

Some approaches to image segmentation include generation of an image segmentation mask. For the purposes of the present disclosure, an image segmentation mask refers to a digital data structure that includes pixel values for a plurality of mask pixels, each corresponding to image pixels of the image being segmented. These masks are often binary, such that mask pixels having one value (such as 1) represent an object or area of interest, and mask pixels having another value (such as 0) represent the background. In general, however, an image segmentation mask may be used to distinguish any suitable number of different regions, objects, and/or other segments within an image, and may use any suitable pixel values to represent such different segments.

Image segmentation masks are generated in various different ways. As examples, image segmentation masks may be generated through thresholding (e.g., based on pixel color values), edge detection, prediction through a suitable machine learning (ML) and/or artificial intelligence (AI) model, and/or in other suitable ways. However, it can be challenging, time consuming, and computationally expensive to generate accurate and detailed segmentation masks—e.g., masks that accurately represent the edges between different objects or regions in the image, even when such edges are fuzzy or include fine detail. This challenge is exacerbated as the resolution of the image increases, potentially requiring considerable computational complexity and memory usage in order to achieve high accuracy. As a result, existing segmentation algorithms often generate masks at a smaller resolution, which can lead to lower accuracy.

Due to the challenges associated with directly predicting accurate and detailed masks, some approaches focus on the refinement of “coarse” masks. A coarse mask refers to a segmentation mask that defines different segments within the image, but may include errors, such as portions of a background scene that are erroneously classified as being part of a foreground object (or vice versa). Refining refers to a process by which a refined segmentation mask is generated based on an existing coarse segmentation mask, which may include correcting errors and/or improving the level of detail in the coarse segmentation mask. However, such coarse mask refinement approaches are usually specific to one particular image segmentation algorithm or model, and hence cannot be generalized to refine coarse masks produced by other segmentation methods. Furthermore, the diverse types of errors (e.g., errors along object boundaries, failure to capture fine-grained details in high-resolution images, and/or and errors due to incorrect semantics) that may be present in coarse masks can pose a great challenge during mask refinement, thus causing underperformance.

Accordingly, the present disclosure is directed to techniques for image segmentation, in which an initial image segmentation mask (e.g., a coarse mask output by an image segmentation model) is input to a trained diffusion model, which outputs a refined version of the image segmentation mask. For instance, over a series of iteration cycles, the diffusion model may iteratively change pixel values of the initial image segmentation mask to correct errors and gradually converge toward a more accurate, refined version of the initial segmentation mask. In other words, according to the techniques described herein, the task of segmentation mask refinement may be represented as a data generation process, where refinement is achieved through a sequence of denoising diffusion steps applied to an initial image segmentation mask (e.g., a coarse mask) to generate a higher-accuracy, refined image segmentation mask.

The techniques described herein therefore provide various technical benefits in the field of computerized image segmentation. Firstly, they enable enhanced precision in image segmentation, particularly in delineating complex boundaries. This is achieved through the use of a discrete diffusion process, allowing for iterative refinement of segmentation masks. These techniques beneficially are model agnostic, making them versatile and applicable across various segmentation models and algorithms. Furthermore, the techniques described herein may enhance the overall quality of segmentation, contributing to more accurate and reliable analysis in applications such as medical imaging and object recognition.

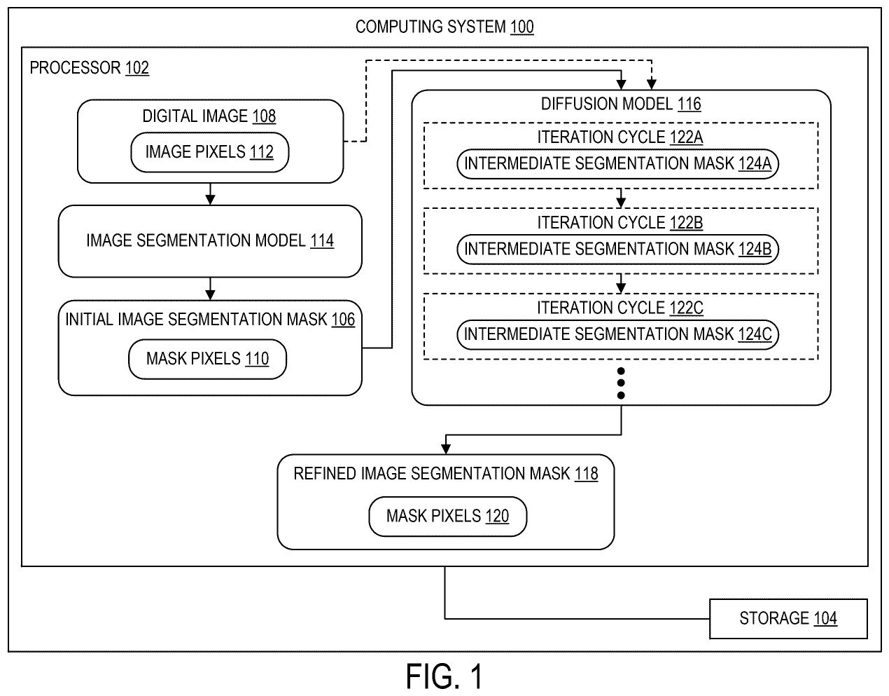

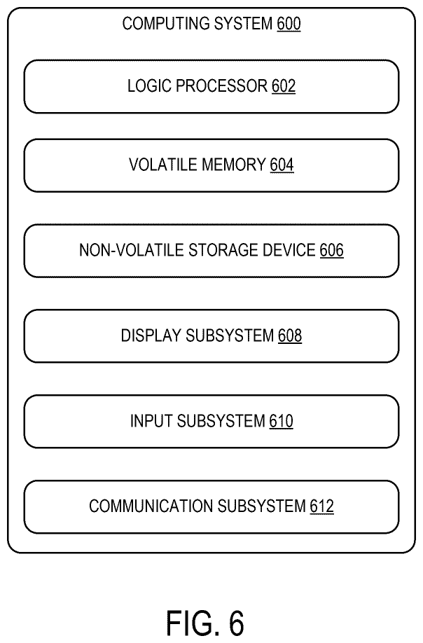

FIG. 1 schematically shows an example computing system 100. The computing system 100 includes a processor 102 and a storage device 104 holding instructions executable by the processor. As examples, the processor may include one or more central processing units (CPUs), graphics processing units (GPUs), tensor units, application-specific integrated circuits (ASICs), and/or other types of processing devices. The storage device 104 may include volatile memory and/or non-volatile storage. In some examples, the computing system 100 is distributed across a plurality of physical computing devices, whereas in other examples, the processor 102 and the storage device 104 are included in a single physical computing device. In general, a computing system as described herein may have any suitable capabilities, hardware configuration, and form factor, and may include any suitable number of one or more computing devices. In some examples, computing system 100 is implemented as computing system 600 described below with respect to FIG. 6.

As shown, computing system 100 has received an initial image segmentation mask 106 for an image 108. In other words, the initial image segmentation mask is generated for image 108 using a suitable image segmentation technique, as discussed above. The initial image segmentation mask may be described as a “coarse” image segmentation mask—e.g., it may include relatively low detail and/or include significant errors. The computing system may receive image 108 from any suitable source—e.g., the image may be loaded from a storage device of the computing system (e.g., storage device 104), loaded from an external storage device communicatively coupled with the computing system, received over a suitable computer network, or captured by a camera device integrated into or communicatively coupled with the computing system.

As shown in FIG. 1, the initial image segmentation mask includes a plurality of mask pixels 110. The initial image segmentation mask may include any suitable number of mask pixels, corresponding to the image pixels 112 of the input image 108. In some examples, the number of mask pixels in the segmentation mask is equal to the number of image pixels in the digital image—e.g., the mask and the image have the same pixel resolution. The mask pixels 110 of the initial image segmentation mask 106 each have pixel values. As discussed above, in some cases, image segmentation masks are binary, where two different pixel values (such as 0 and 1) are used to distinguish two different segments within the image—e.g., distinguishing a foreground object from a background scene. In general, however, a segmentation mask may define any suitable number of different segments within the image, which may be represented by any suitable pixel values of the mask pixels.

The initial image segmentation mask may be generated by any suitable computing device and using any suitable image segmentation techniques. As one non-limiting example, the initial image segmentation mask may be generated by the computing system 100, and thus “receiving” the initial image segmentation mask may include generating the initial image segmentation mask. In the example of FIG. 1, the initial image segmentation mask is generated by an image segmentation model 114 of computing system 100. In other words, in some examples, the initial image segmentation mask is output by an image segmentation model trained to output image segmentation masks for input images. Such a model may take any suitable form—e.g., implemented via any suitable ML and/or AI technologies. In one non-limiting example, the image segmentation model is a convolutional neural network (CNN). In other examples, the image segmentation model may use another suitable underlying architecture, such as a transformer-based architecture.

In some examples, the initial image segmentation mask may be generated by a different computing device, and thus computing system 100 may “receive” the initial image segmentation mask in another suitable way, from another suitable source. As one example, receiving the initial image segmentation mask may include loading the initial image segmentation mask from a storage device of the computing system (e.g., storage device 104), and/or loading the image segmentation mask from an external storage device communicatively coupled with the computing system. As another example, the initial image segmentation mask may be received over a suitable computer network, such as a local-area network or a wide-area network (e.g., the Internet).

In any case, in FIG. 1, the computing system inputs the initial image segmentation mask to a diffusion model 116. The diffusion model is trained to change pixel values of a plurality of mask pixels of the initial image segmentation mask (e.g., one or more of the mask pixels 110) to thereby generate a refined image segmentation mask 118. In the example of FIG. 1, the refined image segmentation mask includes a set of mask pixels 120, which differ at least partially from the mask pixels 110 of the initial image segmentation mask 106. In some examples, the image is input to the diffusion model with the initial image segmentation mask, and is processed by the diffusion model with the initial image segmentation mask in generating the refined image segmentation mask. This is shown in FIG. 1, in which image 108 is also input to diffusion model 116 with initial image segmentation mask 106.

In general, a diffusion model may be described as a type of generative model that synthesizes data, such as images or audio, by refining random noise through a learned reverse diffusion process. Diffusion models may be characterized by gradually reducing noise continuously or over multiple discrete steps to generate a coherent output from a random or partially random input. Diffusion models include both discrete diffusion models and continuous diffusion models. Continuous diffusion models operate on the principle of transforming data through a smooth, uninterrupted process, where changes occur in a fluid and ongoing manner without distinct stages. In contrast, discrete diffusion models function through a series of distinct, separate steps. Each step in this process represents a clear transition, with the model adding or removing noise in quantized intervals. It will be understood that the techniques described herein may be implemented through either or both of discrete and continuous diffusion models.

In the example of FIG. 1, the diffusion model is a discrete diffusion model that iteratively generates a series of intermediary image segmentation masks for the image on a series of iteration cycles. This may be done by, on each iteration cycle, changing pixel values of one or more mask pixels of a preceding image segmentation mask generated on a preceding iteration cycle. In the example of FIG. 1, the diffusion model performs a plurality of iteration cycles, including cycles 122A, 122B, and 122C. On each iteration cycle, a corresponding intermediate image segmentation mask 124A-C is generated. In this manner, over the plurality of iteration cycles, the initial image segmentation mask is gradually refined to converge toward the refined image segmentation mask.

The diffusion model may use any suitable underlying architecture for generating the intermediate image segmentation mask on each iteration cycle. In some examples, a trained neural network is used to output the series of intermediary image segmentation masks. More particularly, in some examples, the trained neural network uses a U-net architecture. It will be understood that these examples are non-limiting. As additional non-limiting examples, the diffusion model may be implemented in tandem with a transformer-based architecture, a variational autoencoder (VAE), a generative adversarial network (GAN), a recurrent neural network, etc.

Diffusion models may be trained in a two-phase process, including a forward diffusion phase and a reverse diffusion phase. In some cases, the forward diffusion phase q(x_{1:T}|x₀) uses a Markov or None-Markov chain to gradually convert the data distribution x₀˜q(x₀) into complete noise x_{T}, whereas the reverse diffusion phase deploys a gradual denoising procedure pθ(x_{0:T}) that transforms the random noise back into the original data distribution.

In general, continuous diffusion models adhere to the Gaussian assumption and define p(x_{T})=N(x_{T}|0, 1). The mean and variance of the forward diffusion phase may be defined by a hyperparameter βₜ, while the reverse diffusion phase utilizes a mean and variance derived from model predictions. This may be formulated as:

$$\begin{matrix}q ( {x}_{t} \vert {x}_{t - 1} ) = N ( {x}_{t} \vert \sqrt{1 - {β}_{t}} {x}_{t - 1} , {β}_{t} I ) , \\ {p}_{θ} ( {x}_{t - 1} \vert {x}_{t} ) = N ( {x}_{t - 1} \vert {u}_{θ} ( {x}_{t} , t ) {\sum }_{θ} ( {x}_{t} , t ) ) .\end{matrix}$$

In the case of discrete diffusion models, x_{T} is defined to adhere to the Bernoulli distribution B(x_{T}|0.5). The forward diffusion phase and reverse diffusion phase may be represented as:

$$\begin{matrix}q ( {x}_{t} \vert {x}_{t - 1} ) = B ( {x}_{t} \vert {x}_{t - 1} ( 1 - {β}_{t} ) + 0.5 {β}_{t} ) , \\ {p}_{θ} ( {x}_{t - 1} \vert {x}_{t - 1} ) = B ( {x}_{t - 1} \vert {f}_{b} ( {x}_{t} , t ) ) .\end{matrix}$$

Where βₜ∈(0,1) is a hyperparameter and f_{b}(xₜ, t) is a model predicting Bernoulli probability. More generally, the forward diffusion phase of a discrete diffusion model can be defined as a discrete random variable transitioning among multiple states. A states-transition distribution Qₜ may be used to characterize this process:

$${[ {Q}_{t} ]}_{m , n} = ( {x}_{t} = n \vert {x}_{t - 1} = m ) .$$

In view of this, a diffusion model according to the techniques described herein may be applied to refine coarse masks generated via any suitable image segmentation technique. In some examples, the diffusion model may be trained in a two-phase training process including a forward diffusion phase and a reverse diffusion phase. In the forward diffusion phase, the diffusion model may employ a discrete diffusion process, which may be formulated as a unidirectional random states-transition, to gradually degrade the ground truth mask into a training coarse segmentation mask. In other words, the forward diffusion phase may include iteratively adding noise to a ground truth image segmentation mask to generate a training coarse segmentation mask. In some cases, the forward diffusion phase is a unidirectional process in which every mask pixel of the ground truth image segmentation mask is transitioned from a fine state to a coarse state. In the reverse diffusion phase, the diffusion model may begin with a coarse segmentation mask, and then gradually transition pixels in the coarse segmentation mask to a refined state, thereby correcting wrongly-predicted areas in the coarse segmentation mask. In other words, in some examples, the reverse diffusion phase includes iteratively changing pixel values of a coarse segmentation mask to generate a refined segmentation mask, during inference.

Focusing now on the forward diffusion process, the ground truth mask (represented by m₀) is transitioned into a training coarse segmentation mask (represented by m_{T}). At any intermediate timestamp t, where t∈{1, 2, . . . . T−1}, and T represents the total number of iteration cycles, the intermediary image segmentation mask m_{T} is in a transitional phase between m₀ and m_{T}. Each mask pixel in m_{T} occupies one of two states: fine and coarse. The forward diffusion phase may therefore be formulated as a states-transition between these two states. Pixels in the fine state will retain their values from m₀ and vice versa. At each iteration cycle during the forward diffusion phase, the diffusion model uses the preceding intermediary image segmentation mask mₜ₋₁, coarse mask m_{T}, and a states-transition probability as inputs, and outputs an intermediary image segmentation mask for the current iteration cycle mₜ. In the context of the forward diffusion process, the states-transition probability describes the probability of every pixel in mₜ₋₁ transition to the coarse state. In some cases, this may include performing Gumbel-max sampling according to the states-transition probability, to obtain the transitioned pixels. At this time, the transitioned mask pixels will have values from m_{T}, while the non-transitioned pixels remain unchanged.

Notably, as discussed above transitioning mask pixels from one state to another is in some cases a unidirectional process—e.g., during the forward diffusion phase, pixels only transition from fine to coarse. This may beneficially ensure that the forward diffusion phase converges to the training coarse segmentation mask, despite each iteration cycle introducing randomness. This stands in contrast to other diffusion model implementations, in which the forward process converges to random noise.

Using the reparameterization step, a binary random variable x may be introduced into the above process. The representation xₜ^{i,j} refers to a one-hot vector indicating the state of a pixel (i,j) in the intermediary image segmentation mask mₜ. The sets x₀^{i,j}=[1,0] and x_{T}^{i,j}=[0,1] respectively represent the fine and coarse states. The forward process can therefore be formulated as:

$$q ( {x}_{t}^{i , j} \vert {x}_{t - 1}^{i , j} ) = {x}_{t - 1}^{i , j} {Q}_{t} , where {Q}_{t} = [ \begin{matrix}{β}_{t} & 1 - {β}_{t} \\ 0 & 1\end{matrix} ] ,$$

where βₜ∈[0,1], and 1−βₜ corresponds to the states-transition probability. The form of Qₜ may serve to manifest the unidirectional property of the states-transition process—e.g. pixels in the coarse state do not transition back to the fine state as q(xₜ[0,1])=[0,1].

The marginal distribution can be formulated as:

$$q ( {x}_{t}^{i , j} \vert {x}_{0}^{i , j} ) = {x}_{0}^{i , j} {Q}_{1} {Q}_{2} … {Q}_{t} = {x}_{0} {\overline{Q}}_{t} = {x}_{0} [ \begin{matrix}{\overline{β}}_{t} & 1 - {\overline{β}}_{t} \\ 0 & 1\end{matrix} ]$$

where β̅ₜ=B₁β₂ . . . βₜ. Given this, the intermediary image segmentation mask for any intermediate timestamp may be obtained without the need for step-by-step sampling, beneficially facilitating faster model training.

Turning now to the reverse diffusion phase, the training coarse segmentation mask is refined correct errors and/or improve the level of detail. However, since the fine mask and the reversed states-transition probability are unknown, a neural network may be trained to predict the fine mask at each timestep—e.g., to thereby output an intermediary image segmentation mask at each time step. The predicted fine mask at an iteration cycle t may be represented as \tilde{m}_{0|t}, the confidence score for the predicted fine mask is represented as p_{θ}(\tilde{m}_{0|t}), and the neural network may be represented as f_{Θ}.

\tilde{m}_{0|t}p_{θ}(\tilde{m}_{0|t})=f_{θ}(I,mₜ,t)

where I is the corresponding image being segmented.

To obtain the reversed states-transition probability, the posterior at timestep t−1 may be formulated as:

$$q ( {x}_{t - 1} \vert {x}_{t} , {x}_{0} ) = \frac{q ( {x}_{t} \vert {x}_{t - 1} , {x}_{0} ) q ( {x}_{t - 1} \vert {x}_{0} )}{q ( {x}_{t} \vert {x}_{0} )} = \frac{{x}_{t} {Q}_{t}^{T} ⊙ {x}_{0} {\overline{Q}}_{t - 1}}{{x}_{0} {\overline{Q}}_{t} {Q}_{t}^{T}} ,$$

where the fine state x₀ is set to [1,0] during training, indicating ground truth. While during inference, x₀ is unknown, as the predicted \tilde{m}_{0|t} may not be accurate. Since the confidence score p_{θ}(\tilde{m}_{0|t}) represents the model's confidence level for each pixel being correct, p_{θ}(\tilde{m}_{0|t}) can also be interpreted as the probability of that pixel being in the fine state.

As such, the state of every pixel in \tilde{m}_{0|t} could potentially be obtained via thresholding, where:

$${x}_{0 \vert t}^{i , j} = \{ \begin{matrix}[ 1 , 0 ] & if {{p}_{θ} ( {\tilde{m}}_{0 \vert t} )}^{i , j} \geq 0.5 \\ [ 0 , 1 ] & otherwise\end{matrix}$$

In this case, pixels with higher confidence scores will have x_{0|t}^{i,j}=[1,0], indicating they are in the fine state, and vice versa. However, in such a one-hot form, the values of the states-transition probabilities will be determined solely by the predefined hyperparameters, which can lead to significant information loss.

As such, the soft transition may be retained by formulating:

$${x}_{0 \vert t}^{i , j} = [ {{p}_{θ} ( {\tilde{m}}_{0 \vert t} )}^{i , j} , 1 - {{p}_{θ} ( {\tilde{m}}_{0 \vert t} )}^{i , j} ] .$$

This in turn allows the reverse diffusion phase to be reformulated as:

$$\begin{matrix}{p}_{θ} ( {x}_{t - 1}^{i , j} \vert {x}_{t}^{i , j} ) = {x}_{t}^{i , j} {P}_{θ , t}^{i , j} , \\ {P}_{θ , t}^{i , j} = [ \begin{matrix}1 & 0 \\ \frac{{{p}_{θ} ( {\tilde{m}}_{0 , t} )}^{i , j} ( {\overline{β}}_{t - 1} , {\overline{β}}_{t} )}{1 - {{p}_{θ} ( {\tilde{m}}_{0 , t} )}^{i , j} {\overline{β}}_{t}} & \frac{1 - {{p}_{θ} ( {\tilde{m}}_{0 , t} )}^{i , j} {\overline{β}}_{t - 1}}{1 - {{p}_{θ} ( {\tilde{m}}_{0 , t} )}^{i , j} {\overline{β}}_{t}}\end{matrix} ] ,\end{matrix}$$

where P_{θ,t}^{i,j} is the reversed states-transition matrix. With the above reversed states-transition probability, mₜ, and \tilde{m}_{0|t} as inputs, the diffusion model can transition a subset of the mask pixels to the fine state at each timestep, thereby correcting erroneous predictions.

At inference time, given a coarse mask m_{T} and the corresponding image I being segmented, all of the mask pixels may be first initialized into the coarse state. Thus, x_{T}^{i,j}=[0,1]. The diffusion model may then iterate between: (1) a forward pass to obtain \tilde{m}_{0|t} and p_{θ}(\tilde{m}_{0|t}); (2) computation of the reversed states-transition matrix P_{θ,t}^{i,j} and xₜ₋₁; and (3) computation of the next intermediary image segmentation mask mₜ₋₁ based on xₜ₋₁ and \tilde{m}_{0|t}. This process may be iteratively repeated until the refined image segmentation mask m₀ is obtained. In other words, according to this process, the pixel values of the one or more mask pixels are changed based at least in part on a state transition probability for each mask pixel, indicating a probability of the mask pixel changing state between the initial image segmentation mask and the refined image segmentation mask. This may take place over any suitable number of iteration cycles. In some examples, a predefined number of iteration cycles are used (e.g., a value chosen to balance accuracy vs processing time), and/or the process may continue until a refined image segmentation mask having higher than a threshold confidence value is generated.

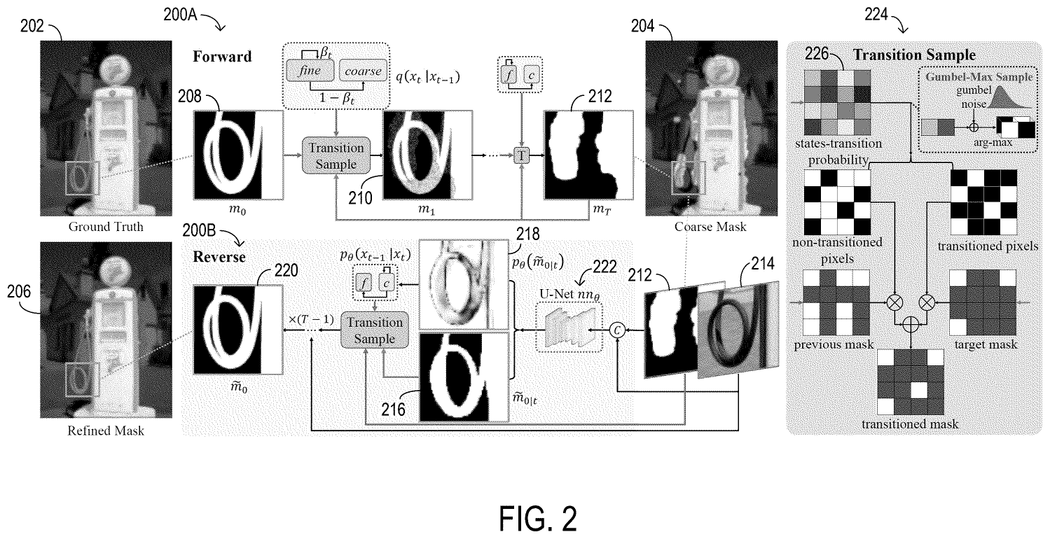

The forward and reverse diffusion phases are schematically illustrated with respect to FIG. 2. Specifically, FIG. 2 schematically represents a forward diffusion phase 200A and a reverse diffusion phase 200B. During the forward diffusion phase, a ground truth image segmentation mask 202 is transformed into a training coarse segmentation mask 204 via gradual addition of noise. During the reverse diffusion phase, the training coarse segmentation mask 204 is used to generate the training refined segmentation mask 206.

FIG. 2 shows an isolated portion 208 of the ground truth image segmentation mask, which is used to illustrate the forward and reverse diffusion phases. As shown, the ground truth image segmentation mask undergoes pixel state transitions to generate an intermediary image segmentation mask, represented by intermediary mask portion 210. This process is iterated any suitable number of times to obtain the training coarse segmentation mask, a portion of which is shown as coarse mask portion 212. As compared to the initial and intermediary image segmentation masks, the coarse segmentation mask includes classification errors—e.g., pixels of the foreground object have been erroneously classified as the background scene, and vice versa.

In the example of FIG. 2, both the training coarse segmentation mask (represented by coarse mask portion 212) and the input image being segmented (represented by image portion 214) are inputs to the reverse diffusion phase. In this example, at each iteration cycle, a trained neural network outputs a prediction of the fine \tilde{m}_{0|t} 216 and the confidence values for this prediction p_{θ}(\tilde{m}_{0|t}) 218. Based at least in part on the outputs \tilde{m}_{0|t} and p_{θ}(\tilde{m}_{0|t}), one or more mask pixels undergo state transitions to generate the next intermediary image segmentation mask. This process may similarly be iterated any suitable number of times, over any suitable number of iteration cycles, to output the refined mask portion 220 (which is a portion of refined image segmentation mask 206).

In the example of FIG. 2, the trained neural network used in generating the intermediary image segmentation mask at each iteration cycle uses a U-net architecture 222. As one non-limiting example, the U-net architecture may be modified to accept a 4-channel input (e.g., the concatenation of the original image and the image segmentation mask preceding the current iteration cycle), and output a 1-channel refined image segmentation mask. However, as discussed above, the diffusion model may use any of a wide variety of suitable underlying architectures in predicting segmentation masks at each iteration cycle.

In FIG. 2, the pixel sampling and state transitioning is handled via a transition sample module 224. This module serves to randomly sample pixels from the current-cycle mask based on the input states-transition probabilities (represented by states-transition probabilities 226) to thereby change the pixel values to match those in the target mask. During training, the transition sample module transforms the ground truth image segmentation mask into a training coarse segmentation mask, and as such the “target mask” refers to the training coarse segmentation mask. During inference the “target mask” refers to the refined image segmentation mask, and the transition sample module updates the pixel values in the coarse mask at each iteration cycle based on the predicted fine mask and the states-transition probabilities.

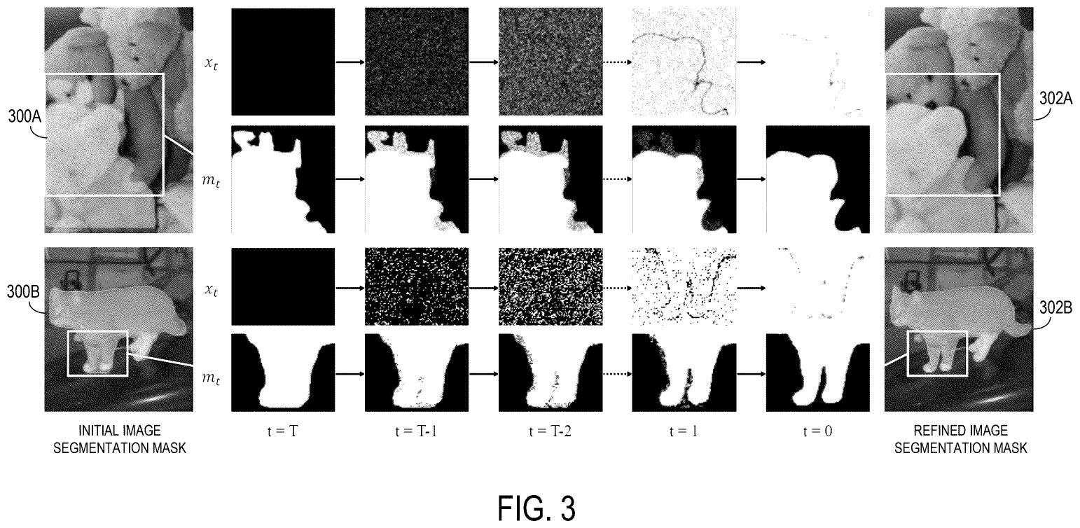

FIG. 3 schematically illustrates iterative generation of a refined image segmentation mask from an initial image segmentation mask. Specifically, FIG. 3 shows two different initial image segmentation masks 300A and 300B. These are input to a diffusion model, which outputs corresponding refined image segmentation masks 302A and 302B. The iterative transition between these two image segmentation masks is shown at five different time steps, ranging from t=T (corresponding to the initial, coarse segmentation mask) to t=0 (corresponding to the refined image segmentation mask). At each time step, the current-cycle image segmentation mask mₜ and the coarse/fine state of each mask pixel xx is shown. As discussed above, during inference, x_{T} for each pixel is initialized as [0,1]. This is gradually refined to obtain the refined image segmentation mask m₀.

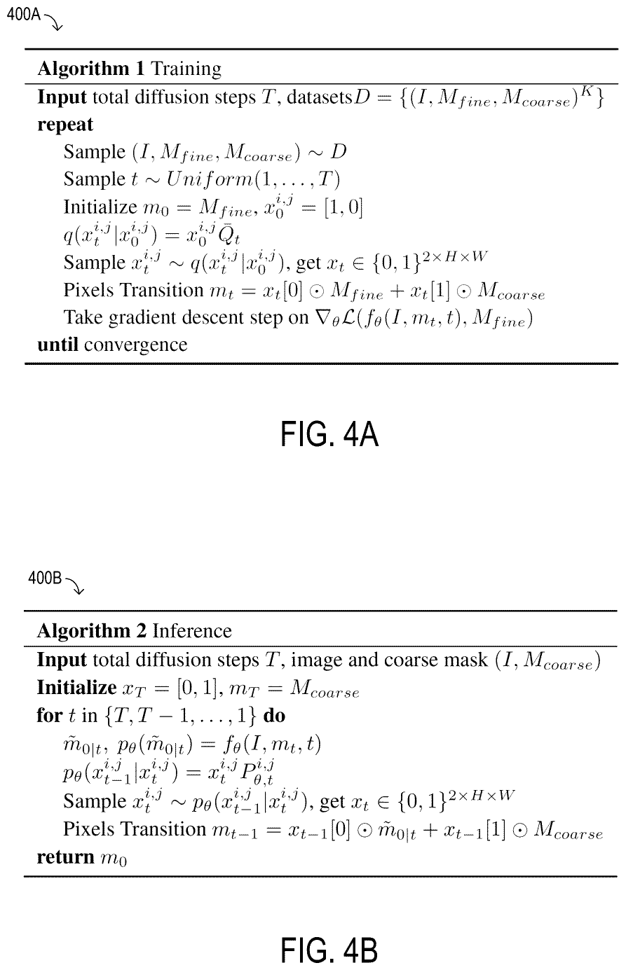

FIGS. 4A and 4B provide non-limiting example algorithms 400A and 400B that may be used respectively for training and inference with a diffusion model, to thereby perform image segmentation mask refinement as described herein. With respect to FIG. 4A, algorithm 400A outlines an example approach to training a diffusion model, focusing on the forward diffusion phase. The method begins by inputting the total number of diffusion steps, T, and a data set, D. The dataset includes tuples of an input image and corresponding coarse and fine image segmentation masks (e.g., a training dataset). Each iteration begins by sampling a tuple from the dataset and a time step, t, from a uniform distribution ranging from 1 to T. Initialization is conducted by setting the initial image segmentation mask, m₀, to the fine mask (e.g., the ground truth image segmentation mask) and the initial pixel state, x₀^{i,j}, to the binary vector [1,0].

The algorithm proceeds by defining a conditional distribution, q(xₜ^{i,j}|x₀^{i,j}), which leverages a state transition probability matrix, Q̅ₜ, to sample a new value for a mask pixel, xₜ^{i,j}, from the conditional distribution. The intermediary image segmentation mask is generated based at least in part on the sampled pixel state, the ground truth image segmentation mask, and the coarse mask. The final step of the iteration involves performing a gradient descent step on the loss function, L, which is a function of the predicted fine mask and the ground truth fine mask. The iterative process repeats until convergence is achieved.

With respect to FIG. 4B, algorithm 400B outlines an example approach to inference using a diffusion model to thereby refine an image segmentation mask. The method begins with the input of the total number of diffusion steps T, an image I, and a coarse mask m_{coarse}. The algorithm proceeds with an initialization step where x_{T} is set to the binary vector [0,1] and the initial image segmentation mask m_{coarse} is set as m_{T}.

For each time step t starting from T and decrementing to 1, the algorithm computes an output intermediary image segmentation mask \tilde{m}_{0|t} and the confidence values p_{θ}(\tilde{m}_{0|t}) using a trained neural network parameterized by θ. It then defines a states-transition distribution p_{θ}(xₜ₋₁^{i,j}|xₜ^{i,j}) for the pixels. The next step involves sampling a new pixel state xₜ₋₁^{i,j} from the states-transition distribution. After sampling, a new intermediary image segmentation mask mₜ₋₁ is generated. The loop iterates backward through the diffusion steps, refining the state of the image segmentation mask at each step, until it reaches t=1. The refined image segmentation mask m₀ is then output.

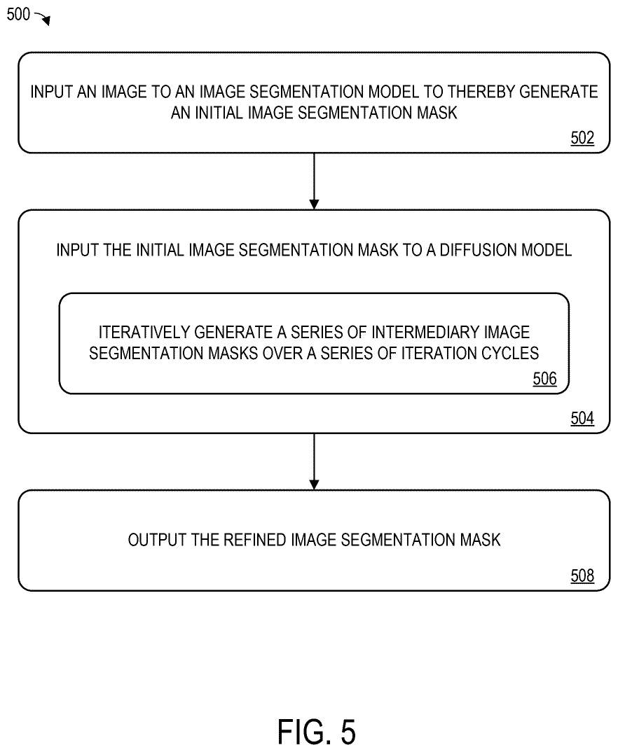

FIG. 5 illustrates an example method 500 for image segmentation mask refinement. Method 500 may be implemented via any suitable computing system of one or more computing devices. A computing device implementing steps of method 500 may have any suitable capabilities, hardware configuration, and form factor. Steps of method 500 may be initiated, terminated, and/or looped at any suitable time and in response to any suitable condition. In some examples, method 500 may be implemented by computing system 100 of FIG. 1 and/or computing system 600 of FIG. 6.

At 502, method 500 includes inputting an image to an image segmentation model to thereby generate an initial image segmentation mask. As discussed above, any suitable image segmentation technique may be used to generate the initial image segmentation model. This may include, for instance, an image segmentation model trained to output segmentation masks for input images, such as a CNN. Notably, the initial image segmentation mask may be a “coarse” image segmentation mask as described above—e.g., it may include pixels that are erroneously misclassified.

At 504, method 500 includes inputting the initial image segmentation mask to a diffusion model. As discussed above, in some examples, the diffusion model is a discrete diffusion model that iteratively refines the initial image segmentation mask over a series of iteration cycles. Thus, at 506, method 500 optionally includes iteratively generating a series of intermediary image segmentation masks over a series of iteration cycles. In this manner, at each iteration cycle, pixel values of one or more mask pixels of a preceding image segmentation mask may be changed, thereby generating a new intermediary image segmentation mask for that iteration cycle, and correcting errors in the original coarse segmentation mask.

At 508, method 500 includes outputting the refined image segmentation mask. It will be understood that an image segmentation mask may be “output” in various suitable ways depending on the implementation. In some embodiments, outputting the image segmentation mask includes passing the output vector to a downstream application, transmitting the image segmentation mask to another computing device (e.g., over a suitable computer network), writing the image segmentation mask to a data file, storing the image segmentation mask in non-volatile storage of the computing device, and/or storing the image segmentation mask in an external storage device communicatively coupled with the computing device.

The present disclosure primarily focuses on refining an image segmentation mask for a single input image. However, it will be understood that this is non-limiting. In some examples, the techniques described herein may be used to refine image segmentation masks for two or more input images simultaneously. Such input images may, for instance, be different sequential or non-sequential video frames of a digital video. This may be achieved by adapting the architecture of the diffusion model to accept input data having a higher number of dimensions. As one non-limiting example, when a U-net architecture is used, the U-net may be modified to a three-dimensional matrix instead of a two-dimensional matrix, which may enable multiple image frames to be processed through the reverse diffusion phase simultaneously.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 600 that can enact one or more of the methods and processes described above. Computing system 600 is shown in simplified form. Computing system 600 may embody the computing system 100 described with respect to FIG. 1. Computing system 600 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 6.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built-in. Non-volatile storage device 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 600 to send and/or receive messages to and/or from other devices via a network such as the Internet.

The following paragraphs provide additional description of the subject matter of the present disclosure. In an example, a computing system comprises: a processor; and a storage device holding instructions executable by the processor to: receive an initial image segmentation mask for an image; input the initial image segmentation mask to a diffusion model trained to change pixel values of a plurality of mask pixels of the initial image segmentation mask to thereby generate a refined image segmentation mask for the image; and output the refined image segmentation mask. In this example or any other example, the diffusion model is a discrete diffusion model that iteratively generates a series of intermediary image segmentation masks for the image by, on a series of iteration cycles, changing pixel values of one or more mask pixels of a preceding image segmentation mask generated on a preceding iteration cycle. In this example or any other example, a trained neural network is used to output the series of intermediary image segmentation masks. In this example or any other example, the trained neural network uses a U-Net architecture. In this example or any other example, the pixel values of the one or more mask pixels are changed based at least in part on a state transition probability for each mask pixel, indicating a probability of the mask pixel changing state between the initial image segmentation mask and the refined image segmentation mask. In this example or any other example, the diffusion model is trained in a two-phase training process including a forward diffusion phase and a reverse diffusion phase, wherein the forward diffusion phase includes iteratively adding noise to a ground truth image segmentation mask to generate a training coarse segmentation mask, and wherein the reverse diffusion phase includes iteratively changing pixel values of the a coarse segmentation mask to generate a training refined segmentation mask during inference. In this example or any other example, the forward diffusion phase is a unidirectional process in which every mask pixel of the ground truth image segmentation mask is transitioned from a fine state to a coarse state. In this example or any other example, the image is input to the diffusion model with the initial image segmentation mask. In this example or any other example, the initial image segmentation mask is output by an image segmentation model trained to output image segmentation masks for input images. In this example or any other example, the image segmentation model is a convolutional neural network (CNN).

In an example, a method for image segmentation mask refinement comprises: at a computing system, receiving an initial image segmentation mask for an image; inputting the initial image segmentation mask to a diffusion model trained to change pixel values of a plurality of mask pixels of the initial image segmentation mask to thereby generate a refined image segmentation mask for the image; and outputting the refined image segmentation mask. In this example or any other example, the diffusion model is a discrete diffusion model that iteratively generates a series of intermediary image segmentation masks for the image by, on a series of iteration cycles, changing pixel values of one or more mask pixels of a preceding image segmentation mask generated on a preceding iteration cycle. In this example or any other example, a trained neural network is used to output the series of intermediary image segmentation masks. In this example or any other example, the pixel values of the one or more mask pixels are changed based at least in part on a state transition probability for each mask pixel, indicating a probability of the mask pixel changing state between the initial image segmentation mask and the refined image segmentation mask. In this example or any other example, the diffusion model is trained in a two-phase training process including a forward diffusion phase and a reverse diffusion phase, wherein the forward diffusion phase includes iteratively adding noise to a ground truth image segmentation mask to generate a training coarse segmentation mask, and wherein the reverse diffusion phase includes iteratively changing pixel values of a coarse segmentation mask to generate a training refined segmentation mask during inference. In this example or any other example, the forward diffusion phase is a unidirectional process in which every mask pixel of the ground truth image segmentation mask is transitioned from a fine state to a coarse state. In this example or any other example, the image is input to the diffusion model with the initial image segmentation mask. In this example or any other example, the initial image segmentation mask is output by an image segmentation model trained to output image segmentation masks for input images. In this example or any other example, the image segmentation model is a convolutional neural network (CNN).

In an example, a computing system comprises: a processor; and a storage device holding instructions executable by the processor to: receive an initial image segmentation mask for an image, the initial image segmentation mask output by a trained image segmentation model; input the initial image segmentation mask to a discrete diffusion model trained to change pixel values of a plurality of mask pixels of the initial image segmentation mask to thereby generate a refined image segmentation mask for the image, wherein the discrete diffusion model iteratively generates a series of intermediary image segmentation masks for the image by, on each of a series of iteration cycles, changing pixel values of one or more mask pixels of a preceding image segmentation mask generated on a preceding iteration cycle; and output the refined image segmentation mask.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a processor; and
a storage device holding instructions executable by the processor to:
receive an initial image segmentation mask for an image;
input the initial image segmentation mask to a diffusion model trained to change pixel values of a plurality of mask pixels of the initial image segmentation mask to thereby generate a refined image segmentation mask for the image; and
output the refined image segmentation mask.

2. The computing system of claim 1, wherein the diffusion model is a discrete diffusion model that iteratively generates a series of intermediary image segmentation masks for the image by, on a series of iteration cycles, changing pixel values of one or more mask pixels of a preceding image segmentation mask generated on a preceding iteration cycle.

3. The computing system of claim 2, wherein a trained neural network is used to output the series of intermediary image segmentation masks.

4. The computing system of claim 3, wherein the trained neural network uses a U-Net architecture.

5. The computing system of claim 2, wherein the pixel values of the one or more mask pixels are changed based at least in part on a state transition probability for each mask pixel, indicating a probability of the mask pixel changing state between the initial image segmentation mask and the refined image segmentation mask.

6. The computing system of claim 1, wherein the diffusion model is trained in a two-phase training process including a forward diffusion phase and a reverse diffusion phase, wherein the forward diffusion phase includes iteratively adding noise to a ground truth image segmentation mask to generate a training coarse segmentation mask, and wherein the reverse diffusion phase includes iteratively changing pixel values of the a coarse segmentation mask to generate a training refined segmentation mask during inference.

7. The computing system of claim 6, wherein the forward diffusion phase is a unidirectional process in which every mask pixel of the ground truth image segmentation mask is transitioned from a fine state to a coarse state.

8. The computing system of claim 1, wherein the image is input to the diffusion model with the initial image segmentation mask.

9. The computing system of claim 1, wherein the initial image segmentation mask is output by an image segmentation model trained to output image segmentation masks for input images.

10. The computing system of claim 9, wherein the image segmentation model is a convolutional neural network (CNN).

11. A method for image segmentation mask refinement, the method comprising:
at a computing system, receiving an initial image segmentation mask for an image;
inputting the initial image segmentation mask to a diffusion model trained to change pixel values of a plurality of mask pixels of the initial image segmentation mask to thereby generate a refined image segmentation mask for the image; and
outputting the refined image segmentation mask.

12. The method of claim 11, wherein the diffusion model is a discrete diffusion model that iteratively generates a series of intermediary image segmentation masks for the image by, on a series of iteration cycles, changing pixel values of one or more mask pixels of a preceding image segmentation mask generated on a preceding iteration cycle.

13. The method of claim 12, wherein a trained neural network is used to output the series of intermediary image segmentation masks.

14. The method of claim 12, wherein the pixel values of the one or more mask pixels are changed based at least in part on a state transition probability for each mask pixel, indicating a probability of the mask pixel changing state between the initial image segmentation mask and the refined image segmentation mask.

15. The method of claim 12, wherein the diffusion model is trained in a two-phase training process including a forward diffusion phase and a reverse diffusion phase, wherein the forward diffusion phase includes iteratively adding noise to a ground truth image segmentation mask to generate a training coarse segmentation mask, and wherein the reverse diffusion phase includes iteratively changing pixel values of a coarse segmentation mask to generate a training refined segmentation mask during inference.

16. The method of claim 15, wherein the forward diffusion phase is a unidirectional process in which every mask pixel of the ground truth image segmentation mask is transitioned from a fine state to a coarse state.

17. The method of claim 11, wherein the image is input to the diffusion model with the initial image segmentation mask.

18. The method of claim 11, wherein the initial image segmentation mask is output by an image segmentation model trained to output image segmentation masks for input images.

19. The method of claim 18, wherein the image segmentation model is a convolutional neural network (CNN).

20. A computing system, comprising:
a processor; and
a storage device holding instructions executable by the processor to:
receive an initial image segmentation mask for an image, the initial image segmentation mask output by a trained image segmentation model;
input the initial image segmentation mask to a discrete diffusion model trained to change pixel values of a plurality of mask pixels of the initial image segmentation mask to thereby generate a refined image segmentation mask for the image, wherein the discrete diffusion model iteratively generates a series of intermediary image segmentation masks for the image by, on each of a series of iteration cycles, changing pixel values of one or more mask pixels of a preceding image segmentation mask generated on a preceding iteration cycle; and
output the refined image segmentation mask.
